(19) United States
(12) Patent Application Publication
(10) Pub. No.: US 2004/0180642 A1
(43) Pub. Date: Sep. 16, 2004

(54) Multi-band Gm-C state-variable filters using lossy integrators

(76) Inventors: Mostafa A. Elmala, Beaverton, OR (US); Krishnamurthy Soumyanath, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/389,175

(22) Filed: Mar. 13, 2003

(51) Int. Cl. H04B 1/10

(52) U.S. Cl. 455/306; 455/307

(57) ABSTRACT

A baseband circuit having a transconductance filter (Gm-C filter) to receive a mixer signal. The Gm-C filter includes lossy integrators with coefficients for the filter to provide a filter frequency response that substantially replicates an ideal Gm-C filter.

Low power consumption, small size, light weight, and low cost have been the primary requirements for the development of mobile devices such as portable telephones. Transceivers for these wireless communications devices incorporate filters to filter out unwanted signals, with integration of the filters on a single chip reducing the number of external components and allowing significant reductions in weight and form factor.

In the transceiver, the high frequency signal received by the antenna is modulated to an intermediate frequency and the receiver of the mobile phone selectively extracts the signal it needs. Digital information is extracted from the selected signal, and with the further addition of digital processing, the output is then delivered in the form of clear speech. CMOS circuits have been developed to capture the base-band signals.

To aid in this demodulation process, different types of filter such as an active RC (Resistor-Capacitor) filter, a switched-capacitor filter and a Gm-C (transconductance-capacitor) filter can be fully integrated on the chip. The comparison and tradeoffs between each type of filter may be done in terms of linearity, area, noise and power. Active RC filters provide an advantage of high linearity but suffer from the components accuracy during the IC processing steps. The switched capacitor filters may be accurate and provide linearity but have a high noise figure and need a high clock frequency to sample the signal. In the high-performance electronic circuits for the IF (Intermediate Frequency) stage, analog filters are preferred to provide low cost and low power consumption for high-speed applications. The Gm-C filter may provide frequency tunability but this filter may also suffer from component variations and low linearity of the Gm blocks.

Accordingly, there is a continuing need for better ways to provide filtering in the frequency translation process while providing flexibility for operating a high data-rate wireless transceiver.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates features of the present invention that may be incorporated into a transceiver of a wireless communications device;

FIG. 2 illustrates a Gm-C filter that uses multiple lossy integrator sections each having an amplifier, an integrating capacitor C and a resistor Ro in accordance with the present invention;

FIG. 3 illustrates one embodiment of a Gm-enhanced circuit in accordance with the present invention;

FIG. 4 illustrates a load circuit having an impedance Z_{LOAD} that sets the common mode voltage V_{CM};

FIG. 5 illustrates an embodiment of a degeneration impedance for the lossy integrator;

FIG. 6 illustrates the filter response with k=0 for ideal integrators along with the filter response with k=0.3 for lossy integrators;

FIG. 7 illustrates a particular embodiment for the Gm-C filter having k=1; and

FIG. 8 illustrates a degeneration impedance for the lossy integrators used in the Gm-C filter having k=1.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

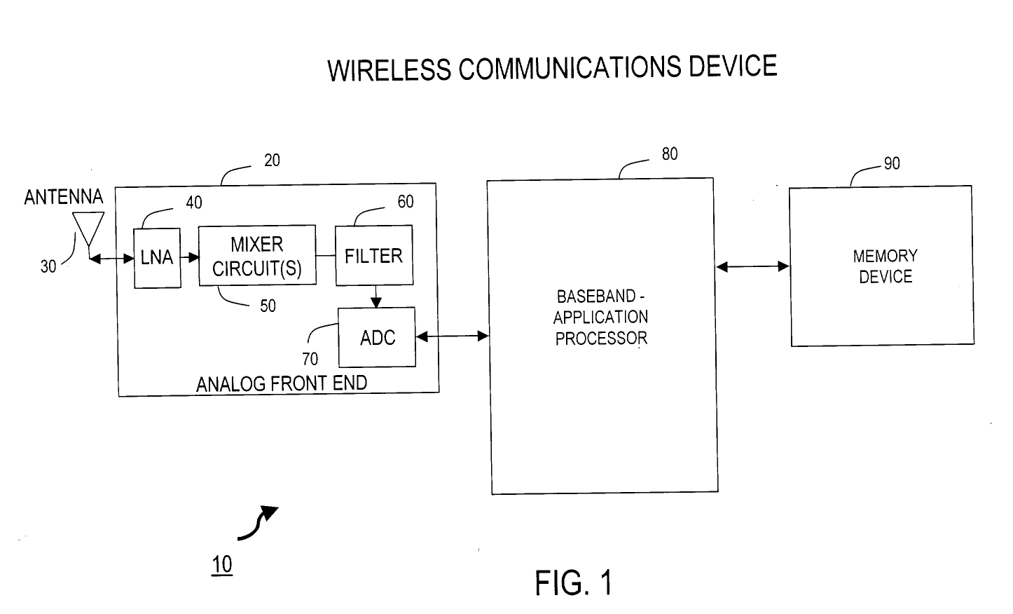

FIG. 1 illustrates features of the present invention that may be incorporated into a wireless communications device 10. The transceiver within an analog front end 20 either receives or transmits a modulated signal from an antenna 30. A Low Noise Amplifier (LNA) 40 amplifies the received signal and a mixer circuit 50 translates the carrier frequency of the modulated signal, up-converting the frequency of the modulated signal in the transmitter and down-converting the frequency of the modulated signal in the receiver. The down-converted signal may be filtered through a filter 60 in accordance with embodiments of the present invention and converted to a digital representation by an Analog-To-Digital Converter 70. A baseband and application processor 80 is connected to analog front end 20 to provide, in general, the digital processing of the received data within communications device 10.

Analog front end 20 may be embedded with processor 80 as a mixed-mode integrated circuit, or alternatively, analog front end 20 may be a stand-alone Radio Frequency (RF) integrated circuit. Accordingly, embodiments of the present invention may be used in a variety of applications, with the claimed subject matter incorporated into microcontrollers, general-purpose microprocessors, Digital Signal Processors (DSPs), Reduced Instruction-Set Computing (RISC), Complex Instruction-Set Computing (CISC), among other electronic components. In particular, the present invention may be used in smart phones, communicators and Personal Digital Assistants (PDAs), base band and application processors, medical or biotech equipment, automotive safety and protective equipment, and automotive infotainment products. However, it should be understood that the scope of the present invention is not limited to these examples.

Further, the principles of the present invention may be practiced in wireless devices that are connected in a Code Division Multiple Access (CDMA) cellular network such as IS-95, CDMA 2000, and UMTS-WCDMA and distributed within an area for providing cell coverage for wireless communication. Additionally, the principles of the present invention may be practiced in Wireless Local Area Network (WLAN), 802.11, Orthogonal Frequency Division Multiplexing (OFDM), and Ultra Wide Band (UWB), among others.

Memory device 90 may be connected to processor 80 to store data and/or instructions. In some embodiments, memory device 90 may be volatile memories such as, for example, a Static Random Access Memory (SRAM), a Dynamic Random Access Memory (DRAM) or a Synchronous Dynamic Random Access Memory (SDRAM), although the scope of the claimed subject matter is not limited in this respect. In alternate embodiments, the memory devices may be nonvolatile memories such as, for example, an Electrically Programmable Read-Only Memory (EPROM), an Electrically Erasable and Programmable Read Only Memory (EEPROM), a flash memory (NAND or NOR type, including multiple bits per cell), a Ferroelectric Random Access Memory (FRAM), a Polymer Ferroelectric Random Access Memory (PFRAM), a Magnetic Random Access Memory (MRAM), an Ovonics Unified Memory (OUM), a disk memory such as, for example, an electromechanical hard disk, an optical disk, a magnetic disk, or any other device capable of storing instructions and/or data. However, it should be understood that the scope of the present invention is not limited to these examples.

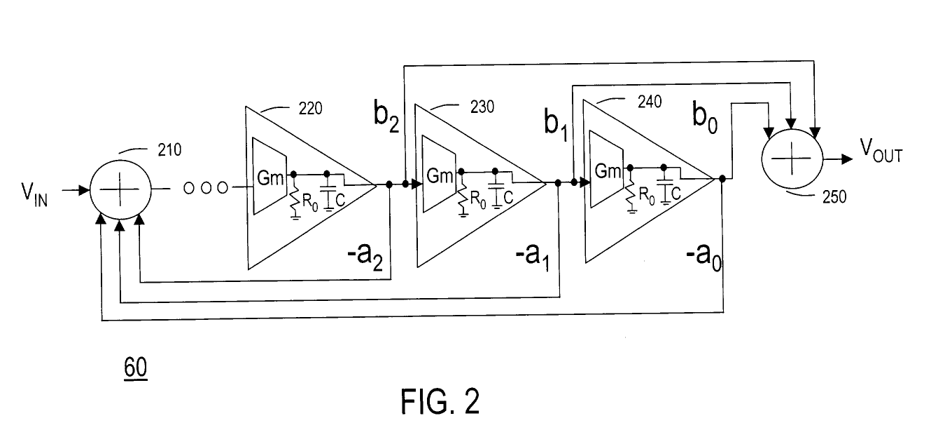

FIG. 2 illustrates a transconductance-C filter that uses multiple Gm-C filter sections that are composed of an amplifier, a capacitor C and a resistor Ro. A transconductor is essentially a transconductance cell (an input voltage creates an output current) with the requirement that the output current is linearly related to the input voltage. This output current is applied to the integrating capacitor. Transconductance-C filters may readily be implemented in fully-integrated form, compatible with the remaining, often digital, system in most desired technologies. The amplifier and capacitor provide simple building blocks for the transconductance-C or Gm-C filter that are well adapted to provide fast and easily tuned continuous-time filters. The resistor accounts for the finite output impedance of the amplifier.

Filter 60 demonstrates low power consumption and high frequency operation, and in order to achieve accuracy, the filter may be adjusted, a task for which features of the present invention provide a simple yet highly accurate method. Gm-C filter 60 uses lossy integrators in the transconductor blocks to reduce the attenuation in the pass band, maximize the attenuation in the stop band, and reduce the filter order. With Gm-C filter 60 compensating for the output impedances in the Gm circuits, the frequency-dependent distortion of the filter may be reduced and filter power consumption may be reduced. FIG. 2 illustrates the lossy integrators, showing a lossy Gm-C integrator 220 cascaded with a lossy Gm-C integrator 230 and a lossy Gm-C integrator 240. The state-variable filter structure has feed-back coefficients −a₂, −a₁ and −a₀ that are summed by summing circuit 210 and feed-forward coefficients b₂, b₁ and b₀ that are summed by summing circuit 250.

Note that the transfer function of a single integrator is given by:

$$H ( s ) = \frac{G m / C}{s + 1 / ( {R}_{0} C )} ,$$

where Gm is the transconductance of the integrator, C is the capacitance at the output of the integrator and R₀ is the finite output impedance of the amplifier.

A pole of the lossy Gm-C integrator is located at a frequency given by:

ωₚ=1/(R₀C).

Note that without accounting for the output impedance of the integrators the transfer function is given by:

$$\frac{{V}_{o u t} ( s )}{{V}_{i n} ( s )} = \frac{{b}_{n} {s}^{n} + {b}_{n - 1} {s}^{n - 1} + … + {b}_{1} s + {b}_{0}}{{s}^{n + 1} + {a}_{n} {s}^{n} + {a}_{n - 1} {s}^{n - 1} + … + {a}_{1} s + {a}_{0}} \qquad Equation ( 1 )$$

However, in accordance with features of the present invention the transfer function of Gm-C filter 60 using lossy integrators in the transconductor blocks is given by:

$$\frac{{V}_{o u t} ( Ω )}{{V}_{i n} ( Ω )} = \frac{{\overline{b}}_{n} {Ω}^{n} + {\overline{b}}_{n - 1} {Ω}^{n - 1} + … + {\overline{b}}_{1} Ω + {\overline{b}}_{0}}{{Ω}^{n + 1} + {\overline{a}}_{n} {Ω}^{n} + {\overline{a}}_{n - 1} {Ω}^{n - 1} + … + {\overline{a}}_{1} Ω + {\overline{a}}_{0}} \qquad Equation ( 2 )$$

Equation 1 represents the non-lossy transfer function that may be converted to Equation 2 to represent the lossy transfer function by providing a frequency transformation on Equation 1 as:

$$\frac{1}{\frac{s}{{ω}_{0}} + \frac{{ω}_{p}}{{ω}_{0}}} ⇔ \frac{1}{\frac{Ω}{{ω}_{0}}} or s ⇔ Ω - k ,$$

where

$${ω}_{0} = \frac{{G}_{m}}{C} ; k = \frac{{ω}_{p}}{{ω}_{0}}$$

and Ω is a new frequency variable.

Thus, the newly developed adjustment method to improve the filter transfer characteristics is based on modifying the structure coefficients. By providing the frequency transformation, the phase-lead at the unity-gain frequency caused by the transconductor output-resistance is compensated by properly adjusting the frequency of the positive zero associated with the signal feed forward path.

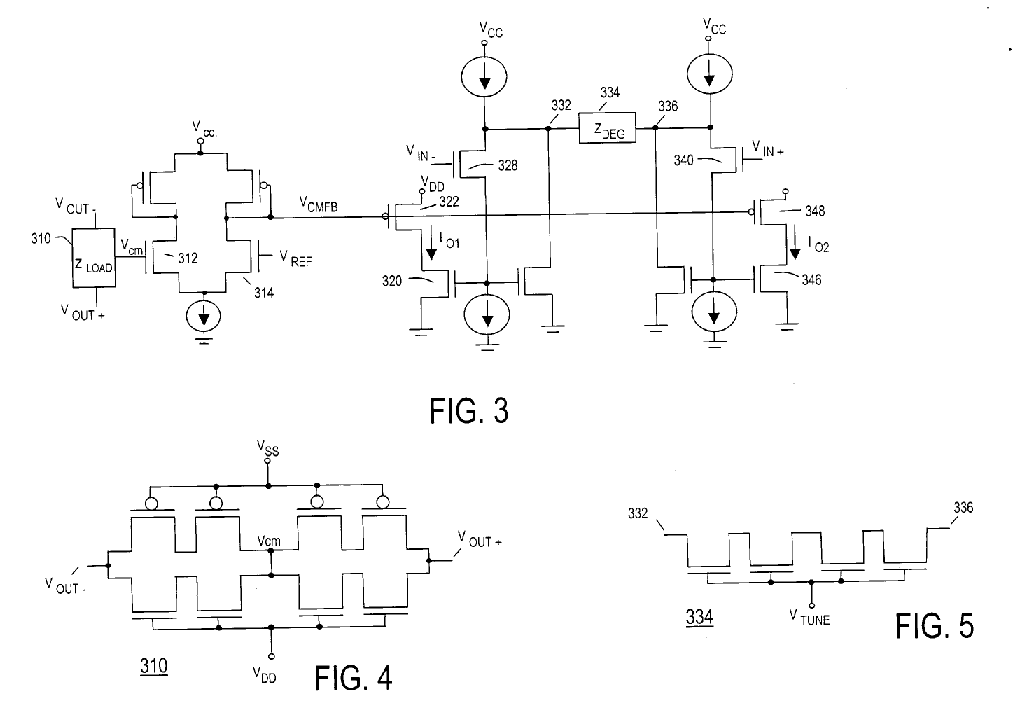

FIG. 3 illustrates one embodiment of a Gm-enhanced circuit having an equivalent Gm of approximately 1/Z_{DEG}, where Z_{DEG} is the degeneration impedance 334. Filter 60 is an amplifier (Gm amp), which transforms an input voltage signal into an output current signal. The differential input voltage V_{IN}− and V_{IN}+ is received at the gates of respective transistors 328 and 340. The output currents 101 and 102 are supplied from the drain terminals of respective transistors 320 and 346.

P-channel transistors 322 and 348 are connected to respective transistors 320 and 346, with the gates of the P-channel transistors receiving a Common Mode Feedback signal (V_{CMFB}). Common-mode feedback circuits stabilize common-mode voltages for fully-differential analog systems by adjusting the common-mode output currents. The voltage V_{CM} supplied to transistor 312 is compared with the common-mode reference voltage V_{REF} supplied to transistor 314, with the differential voltage V_{CMFB} supplied to transistors 322 and 348.

FIG. 4 illustrates a common-mode load circuit 310 having an impedance Z_{LOAD} that sets the voltage V_{CM} supplied to transistor 312 (see FIG. 3). A number of N-channel transistors are connected in series and in parallel with a number of P-channel transistors connected in series, the gates of the N-channel transistors receiving the voltage V_{DD} and the gates of the P-channel transistors receiving the voltage V_{SS}. Common-mode load circuit 310 receives the differential input voltage V_{IN}− and V_{IN}+ and generates the common-mode signal V_{CM} supplied to the integrators.

FIG. 5 illustrates degeneration impedance 334 implemented as a cascade of transistors operating in the triode region and having an impedance Z_{DEG}. The N-channel transistors receive a control voltage V_{TUNE}, with the series arrangement providing minimal drain-to-source voltage drop for each transistor and providing substantially linear operation.

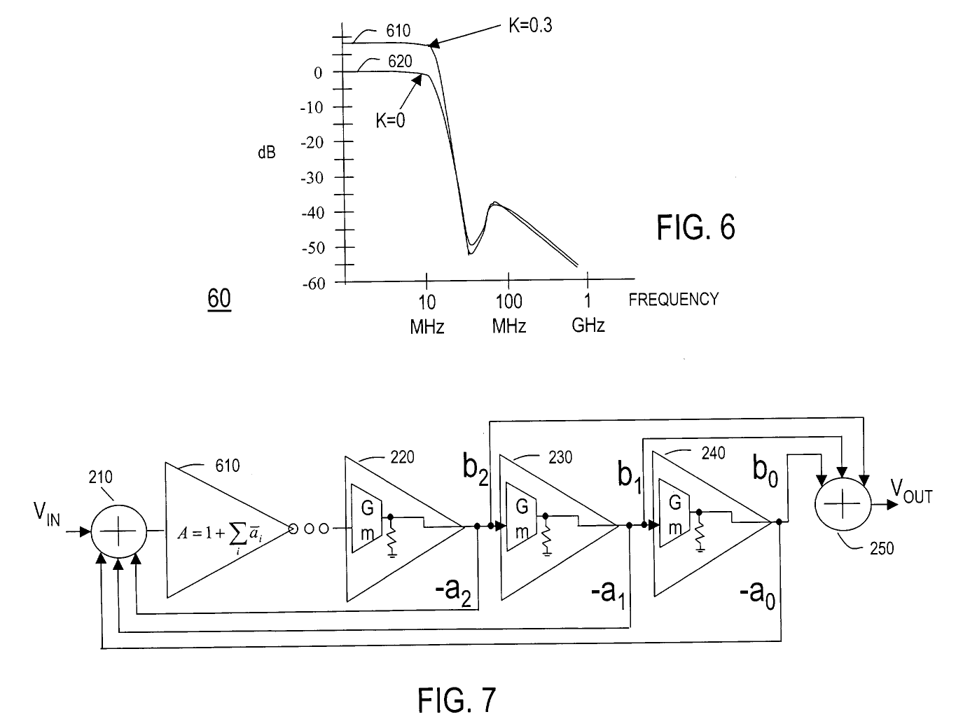

FIG. 6 illustrates the filter response with k=0 for ideal integrators along with the filter response with k=0.3 for lossy integrators. The method provided in accordance with the present invention may improve, for example, the filter transfer characteristics for a third order base-band elliptic low-pass filter having a 10 MHz corner frequency. The Gm-C filter 60 design that includes lossy integrators may be for a k value of 0.3, but note that the filter response may be substantially that of a filter having a k value of 0 if ideal integrators were used. Waveform 610 corresponds to the filter response with k=0.3 while waveform 620 corresponds to the filter response with k=0. Thus, by applying the transformation shown in Equation 2, the filter response using lossy Gm-C integrators designed with k=0.3 may replicate the filter frequency response of an ideal filter designed with k=0 and having non-lossy Gm-C integrators.

Referring to Equation 2, the coefficients in the numerator are not substantially changed following the transformation, but the coefficients in the denominator are changed substantially. By way of example, the coefficients in the numerator may have values of {0.016, 0, 0.584} for k=0 and values of {0.016, −0.009, 0.585} for k=0.3. However, following the transformation the coefficients in the denominator may have values of {1, 1.094, 1.35, 0.58} for k=0 and values of {1, 0.19, 0.96, 0.25} for k=0.3. Thus, in accordance with the present invention the transformation of coefficient values may be a dramatic change in the denominator in order to obtain the ideal transfer characteristic.

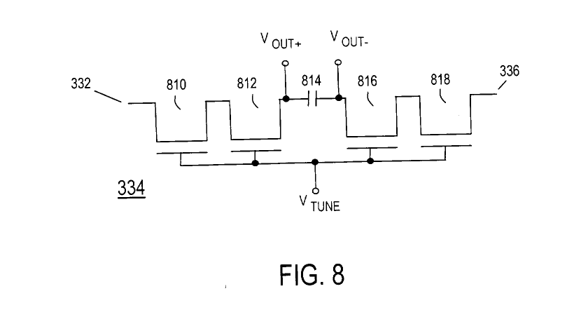

FIGS. 7 and 8 illustrate a particular embodiment of Gm-C filter 60 with k=1 and an embodiment for degeneration impedance 334 (see FIG. 3) also corresponding to the case when k=1. Note that in this particular case with k=1, the integrating capacitor may be inserted between the cascaded transistors. In particular, FIG. 8 shows that the integrating capacitor 814 located in degeneration impedance 334 is coupled through transistors 810 and 812 to node 332 (see FIG. 3) and through transistors 816 and 818 to node 336. In this embodiment and in comparison to the embodiment illustrated in FIG. 2, the integrating capacitor is removed from the output of the integrators and placed within degeneration impedance 334 when k=1.

For simplicity, several embodiments of filter 60 show integrators with single-ended signals. In most integrated applications it is desirable to keep the signals fully differential. Fully differential circuits have better noise immunity and distortion properties. For this reason, the Gm-C integrator used in these embodiments may be single-ended or fully differential.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method comprising:
selecting feedback coefficients for a transconductance filter through a frequency transformation of a filter transfer function to account for a lossy integrator in the transconductance filter that differs from feedback coefficients for a non-lossy integrator.

2. The method of claim 1, wherein accounting for a finite output impedance of the lossy integrator when selecting the feedback coefficients for the transconductance filter further includes modifying the k value of the transconductance filter.

3. The method of claim 1 further including selecting feed forward coefficients for the transconductance filter that are substantially the same for the lossy integrator as the non-lossy integrator.

4. The method of claim 1 wherein selecting feedback coefficients for a transconductance filter through a frequency transformation of a filter transfer function further includes defining a new frequency variable.

5. The method of claim 1 further including cascading multiple lossy integrators in the transconductance filter.

6. A method comprising:
incorporating feedback coefficients and feed forward coefficients for a transconductance filter using lossy integrators to substantially replicate the transconductance filter response using non-lossy integrators.

7. The method of claim 6 further including accounting for a finite output impedance of the lossy integrators by selecting the feedback coefficients for a filter k value that is different than a filter k value for the transconductance filter with non-lossy integrators.

8. The method of claim 6 further including structuring the transconductance filter with serially connected lossy integrators.

9. The method of claim 6 wherein the transconductance filter further includes summing the feedback coefficients.

10. A method comprising:
providing a Gm-C filter where coefficients of the Gm-C filter are designed for finite impedances of lossy integrators to provide a filter frequency response that substantially replicates an ideal Gm-C filter.

11. The method of claim 10, further including:
providing a Gm-C filter with a lossy integrator transfer function, where feedback coefficients of the Gm-C filter are substantially different than feedback coefficients of the ideal Gm-C filter.

12. The method of claim 10, where the lossy integrators further include providing a degradation impedance having at least two transistors, with an integrating capacitor placed between the transistors.

13. The method of claim 12, further including structuring the Gm-C filter with serially connected lossy integrators and one amplifier.

14. A system comprising:
a mixer circuit coupled to receive a modulated signal that is down-converted to provide a signal;
a processor that includes a Gm-C filter having lossy integrators with coefficients for the Gm-C filter to provide a filter frequency response that substantially replicates an ideal Gm-C filter; and
a Static Random Access Memory (SRAM) storage device external to the processor and coupled via a bus to the processor.

15. The system of claim 14 wherein the Gm-C filter includes a series of lossy integrators each having a degeneration impedance.

16. The system of claim 15 wherein the degeneration impedance includes cascaded transistors.

17. The system of claim 16 wherein at least one of the cascaded transistors is separated from at least another of the cascaded transistors by a capacitor.

18. The system of claim 17 wherein the capacitor is an integrating capacitor coupled to receive an output current generated by one of the lossy integrators.

19. The system of claim 14 further including:
a common-mode load circuit having an impedance that sets the common mode voltage for the lossy integrator, where the common-mode load circuit includes cascaded N-channel and P-channel transistors.
